(19) United States
(12) Patent Application Publication
(10) Pub. No.: US 2008/0137048 A1
(43) Pub. Date: Jun. 12, 2008

(54) EXPOSURE APPARATUS, OPERATION APPARATUS, COMPUTER-READABLE MEDIUM, AND DEVICE MANUFACTURING METHOD

(75) Inventor: Sentaro Aihara, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/944,233

(22) Filed: Nov. 21, 2007

(30) Foreign Application Priority Data
Dec. 1, 2006 (JP) 2006-326378

(51) Int. Cl. G03B 27/52

(52) U.S. Cl. 355/41

(57) ABSTRACT

An exposure apparatus configured to measure a position of at least one of a mark formed on an original plate and a mark formed on a substrate and to expose the substrate to radiant energy based on the measured position includes a stage configured to hold one of the original plate and the substrate and to be moved, a scope configured to capture an image of the mark formed on one of the original plate and the substrate held by the stage, an input unit configured to be operated to instruct a position of the stage, a display, and a controller configured to combine images respectively captured by the scope at a plurality of positions of the stage instructed by the input unit into a combined image and to cause the display to display the combined image.

### BACKGROUND OF THE INVENTION

1. Field of the Invention

The present invention relates to an exposure apparatus configured to measure the position of at least one of a mark formed on an original plate and a mark formed on a substrate and to expose the substrate to radiant energy based on the measured position.

2. Description of the Related Art

A semiconductor exposure apparatus is configured to print a circuit pattern on a wafer. For example, a stepper uses a mask (or a reticle), which is a transmitting plate with an original circuit pattern formed thereon. A conventional exposure method includes locating a wafer to a predetermined position and exposing the wafer to illumination light through a mask, thereby printing a circuit pattern drawn on the mask onto the wafer.

An operator observes an alignment mark on a mask or a wafer via a microscope, captures an image of the alignment mark with a charge-coupled device (CCD) camera, and performs a positioning (alignment) operation for locating the mask or the wafer with reference to a result of image processing. In this alignment operation, if the operator cannot detect a target mark in a captured image, the operator moves a mask stage or a wafer stage.

Namely, the operator manually moves the mask stage or the wafer stage while monitoring an image from the CCD camera, so that the alignment mark is present in a visual field of the CCD camera. A computer terminal associated with a semiconductor exposure apparatus enables an operator to perform the above-described operation. For example, a conventional technique discussed in Japanese Patent Application Laid-Open No. 11-214287 automatically repeats a mark detection operation if an initial field of the camera fails to detect a mark.

According to the above-described conventional technique, an operator manually searches an alignment mark while moving (operating) a mask stage or a wafer stage displayed on an operation screen of a computer terminal associated with an exposure apparatus. Therefore, an operator performing an alignment mark search work is required to stay in the vicinity of the exposure apparatus.

For example, if an operator performs remote control of an exposure apparatus from an on-line host computer, the operator necessarily goes to a place where the exposure apparatus is installed when the operator performs an alignment mark search work. Therefore, the work efficiency is not good.

Furthermore, a plurality of exposure apparatuses may use a common reticle if the exposure apparatuses manufacture semiconductor devices of the same pattern. In this case, if the automatic alignment processing for a reticle or a wafer is failed, an operator is required to frequently perform a manual alignment mark search work.

However, according to the above-described conventional technique, an operator is required to start a manual alignment search operation from the beginning each time the automatic alignment processing is failed, even if the manual alignment of some reticles or wafers is already finished. Thus, the work efficiency is deteriorated.

### SUMMARY OF THE INVENTION

Exemplary embodiments of the present invention are directed to improvement of the work efficiency in a mark search operation.

According to an aspect of the present invention, an exposure apparatus configured to measure a position of at least one of a mark formed on an original plate and a mark formed on a substrate and to expose the substrate to radiant energy based on the measured position includes a stage configured to hold one of the original plate and the substrate and to be moved, a scope configured to capture an image of the mark formed on one of the original plate and the substrate held by the stage, an input unit configured to be operated to instruct a position of the stage, a display, and a controller configured to combine images respectively captured by the scope at a plurality of positions of the stage instructed by the input unit into a combined image and to cause the display to display the combined image.

According to another aspect of the present invention, an operation apparatus is configured to operate an exposure apparatus, wherein the exposure apparatus includes a stage configured to hold one of an original plate and a substrate and to be moved and a scope configured to capture an image of a mark formed on one of the original plate and the substrate held by the stage, measures a position of the mark, and exposes the substrate to radiant energy based on the measured position. The operation apparatus includes an input unit configured to be operated to instruct a position of the stage, a display, and a controller configured to combine images respectively captured by the scope at a plurality of positions of the stage instructed by the input unit into a combined image and to cause the display to display the combined image.

According to yet another aspect of the present invention, a computer-readable medium is provided including computer-executable instructions stored in a computer-readable medium for operating an expose exposure apparatus including a stage configured to hold one of an original plate and a substrate and to be moved and a scope configured to capture an image of a mark formed on one of the original plate and the substrate held by the stage, wherein the expose exposure apparatus measures a position of the mark and exposes the substrate to radiant energy based on the measured position. The medium includes computer-executable instructions for receiving information instructing a position of the stage from an input unit, computer-executable instructions for combining images respectively captured by the scope at a plurality of instructed positions of the stage into a combined image, and computer-executable instructions for causing a display to display the combined image.

According to yet another aspect of the present invention, a method for manufacturing a device includes exposing a substrate to radiant energy using the above-described exposure apparatus, developing the exposed substrate, and processing the developed substrate to manufacture the device.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain at least some of the principles of the invention.

FIG. 1 illustrates an example configuration of an exposure apparatus according to a first exemplary embodiment of the present invention and an example configuration of a computer terminal that manages the exposure apparatus.

FIG. 2 illustrates an example search operation screen displayed on a display unit of the computer terminal according to the first exemplary embodiment.

FIG. 3 illustrates an example data structure of local area network (LAN) transmission data transmitted between the computer terminal and the exposure apparatus during an alignment mark search operation according to the first exemplary embodiment.

FIG. 4 illustrates an example setting screen displayed when an operator presses a setting screen start button located in a button display field of the search operation screen according to the first exemplary embodiment.

FIG. 5 illustrates an example mark setting screen according to a second exemplary embodiment of the present invention, which can be displayed when an operator presses a mark setting screen start button.

FIG. 6 illustrates an example of a search history file including search information obtained using the search operation screen according to the second exemplary embodiment.

FIG. 7 illustrates an example of a search history screen according to the second exemplary embodiment, which can be displayed when an operator presses a search history screen start button.

FIG. 8 illustrates an example of a search operation screen according to the second exemplary embodiment, which can be displayed when an operator presses a history read button on the search history screen.

FIG. 9 is a flowchart illustrating a device manufacturing method that uses the exposure apparatus according to an exemplary embodiment of the present invention.

FIG. 10 is a flowchart illustrating details of a wafer process in the flowchart of FIG. 9.

FIG. 11 is a flowchart illustrating a procedure of processing performed by a computer terminal according to an exemplary embodiment of the present invention.

### DETAILED DESCRIPTION OF THE EMBODIMENTS

The following description of exemplary embodiments is illustrative in nature and is in no way intended to limit the invention, its application, or uses. It is noted that throughout the specification, similar reference numerals and letters refer to similar items in the following figures, and thus once an item is described in one figure, it may not be discussed for following figures. Exemplary embodiments of the present invention are described below with reference to the attached drawings.

### First Exemplary Embodiment

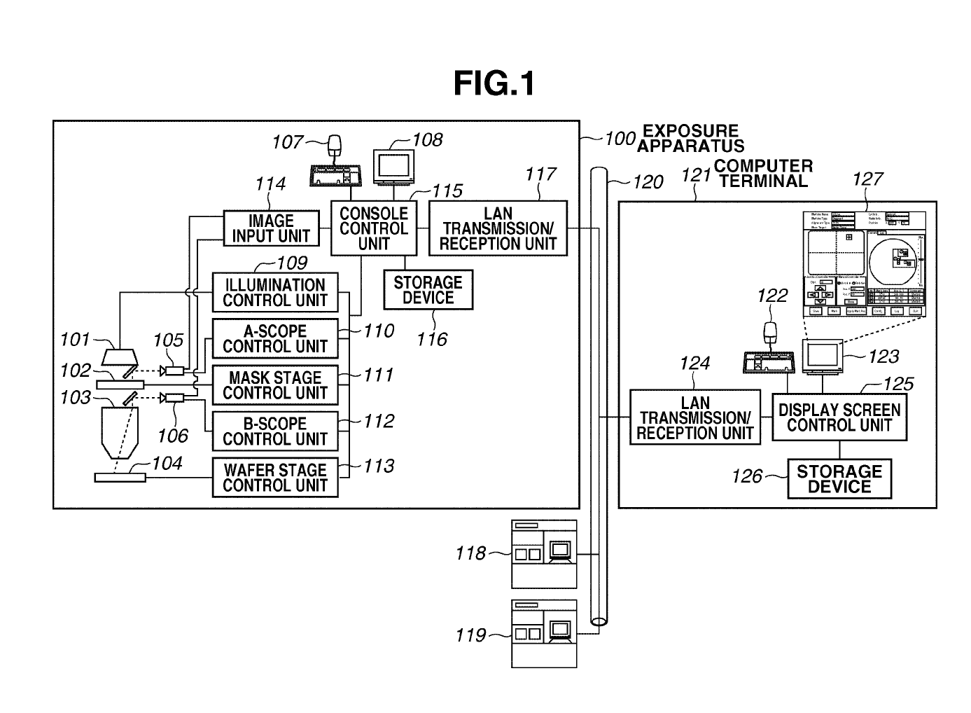

FIG. 1 illustrates an example of a configuration of an exposure apparatus 100 according to a first exemplary embodiment of the present invention and an example of a configuration of a computer terminal 121 that manages the exposure apparatus 100. In FIG. 1, the exposure apparatus 100 is structurally similar to other exposure apparatuses 118 and 119. The exposure apparatuses 100, 118, and 119 are connected to the computer terminal 121 via a local area network (LAN) 120. The exposure apparatus 100 includes a console control unit 115, which, for example, includes a central processing unit (CPU) and a random access memory (RAM), which is an internal memory.

The console control unit 115 controls a display unit 108, such as a cathode ray tube (CRT) or a liquid crystal display, and recognizes an input signal received from an input unit 107, such as a keyboard, a mouse, or a touch panel. Furthermore, the console control unit 115 controls a storage device 116, which is a storage unit, such as a hard disk or a magneto-optical disk (MO).

Furthermore, the console control unit 115 controls a LAN transmission/reception unit 117 connected to the LAN 120 (i.e., an information network in a factory), an illumination control unit 109, an A-scope control unit 110, and a mask stage control unit 111. Furthermore, the console control unit 115 controls a B-scope control unit 112, a wafer stage control unit 113, and an image input unit 114.

Particularly, the console control unit 115 transmits predetermined control commands to the illumination control unit 109, the A-scope control unit 110, and the mask stage control unit 111, thereby controlling the exposure apparatus 100. The mask stage control unit 111 is configured to control a mask stage 102. The wafer stage control unit 113 is configured to control a wafer stage 104.

The illumination control unit 109 receives a control command from the console control unit 115 and controls an illumination unit 101, which is configured to emit exposure light. The A-scope control unit 110 receives a control command from the console control unit 115 and controls an A-scope 105. The A-scope 105 is a microscope capable of observing an alignment mark on a mask (circuit pattern mask) in an alignment operation of the mask. The A-scope 105 can transmit a video signal representing a captured image of the mark to the image input unit 114.

The mask stage control unit 111 receives a control command from the console control unit 115 and controls the movement of the mask stage 102 in an XYZ coordinate system. Thus, the mask stage control unit 111 can adjust a projection position of the mask during exposure processing. The A-scope 105 functions as a mask alignment image capturing unit.

The B-scope control unit 112 receives a control command from the console control unit 115 and controls a B-scope 106. The B-scope 106 is a microscope capable of observing an alignment mark on a wafer (semiconductor wafer) in an alignment operation of the wafer. The B-scope 106 can transmit a video signal representing a captured image of the wafer to the image input unit 114.

The wafer stage control unit 113 receives a control command from the console control unit 115 and controls the movement of the wafer stage 104 in an XYZ coordinate system. Thus, the wafer stage control unit 113 can adjust an exposure position of the wafer during exposure processing. A projection lens 103 is necessary when a reduced pattern of the mask is printed on the wafer. The B-scope 106 functions as a wafer alignment image capturing unit.

The image input unit 114 receives video signals from the A-scope 105 and the B-scope 106 and stores the received video signals in its internal image memory. The image input unit 114 outputs the video signals to the console control unit 115. In this case, the console control unit 115 receives a video signal from the A-scope 105 when the alignment object is the mask stage 102 and receives a video signal from the B-scope 106 when the alignment object is the wafer stage 104.

The console control unit 115 converts, at predetermined time intervals, a received video signal into still images and stores the still images in its internal memory. Then, the console control unit 115 generates transmission data including identification information of the exposure apparatus 100 and positional information of the imaging object in addition to the still images stored in the internal memory. Furthermore, the console control unit 115 transmits the transmission data to the LAN transmission/reception unit 117, which can communicate with an external apparatus via the LAN 120.

The computer terminal 121 is an operation terminal that enables an operator to perform a search operation of an alignment mark. The computer terminal 121 can communicate with each of the exposure apparatuses 100, 118, and 119 via the LAN 120. Hereinafter, the computer terminal 121 is referred to as an external computer terminal 121. The external computer terminal 121 can be installed in a clean room together with the exposure apparatuses 100, 118, and 119, or can be installed in another room.

The external computer terminal 121 includes a display screen control unit 125, which controls a display unit 123, such as a CRT or a liquid crystal display. Furthermore, the external computer terminal 121 recognizes a signal received from an input unit 122, such as a keyboard or a mouse, and controls a storage device 126, such as a hard disk or an MO.

Furthermore, the display screen control unit 125 controls a LAN transmission/reception unit 124, which is connected to the LAN 120 (i.e., an information network in a factory). The LAN transmission/reception unit 124 receives LAN transmission data from the exposure apparatus 100. The display screen control unit 125 analyzes the received LAN transmission data. The display screen control unit 125 generates a search operation image 127 (i.e., a search result of an alignment mark) from the analysis information of the LAN transmission data. The display unit 123 displays the search operation image 127. The display screen control unit 125 and the search operation image 127 function as a unit configured to detect an alignment mark of a mask (circuit pattern mask) or a wafer (semiconductor wafer).

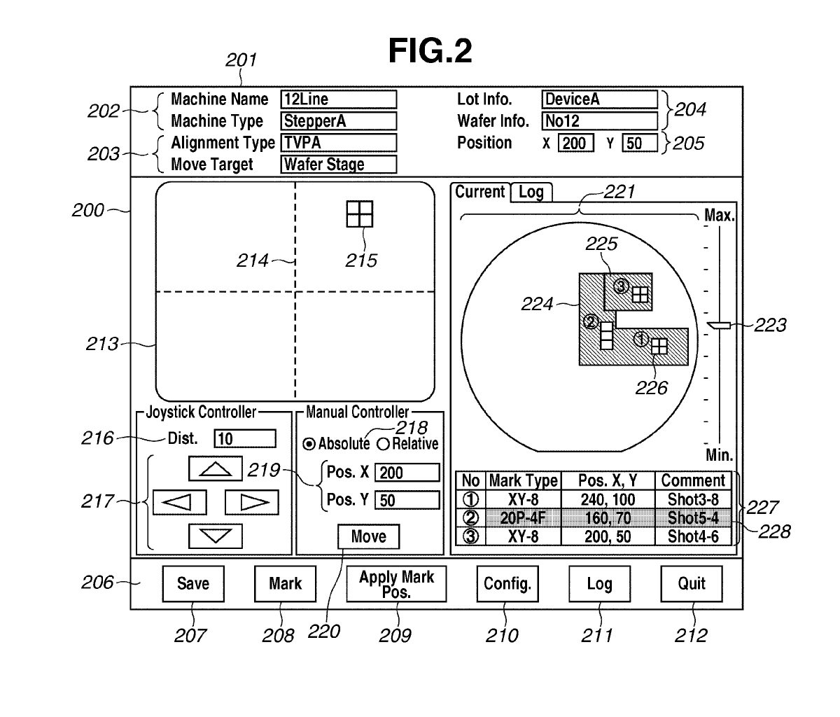

FIG. 2 illustrates an exemplary search operation screen displayed on the display unit 123 of the external computer terminal 121. The search operation image 127 displayed on the display unit 123 corresponds to a search operation screen 200 illustrated in FIG. 2. A state display field 201 positioned at an upper part of the search operation screen 200 includes an apparatus information display field 202, which displays apparatus information identifying the exposure apparatus 100, which is a search object.

The state display field 201 further includes an alignment information display field 203, which displays an alignment type that requires a re-search operation due to failure in a mark search operation performed by the exposure apparatus 100 or information on a target stage (a drive object) identified by the search.

The state display field 201 further includes a material information display field 204, which displays identification information of a search object, such as a lot, a wafer, or a mask. The state display field 201 further includes an imaging position display field 205, which displays positional information of an imaging object, such as a wafer or a mask.

The information content displayed in each of the alignment information display field 203, the material information display field 204, and the imaging position display field 205 reflects the analysis on the information contained in the LAN transmission data received from the exposure apparatus 100 via the LAN 120.

Namely, the display unit 123 receives an analysis result from the display screen control unit 125, and displays the analysis result in the alignment information display field 203, the material information display field 204, or the imaging position display field 205 of the state display field 201. The display unit 123 updates the positional information of an imaging object displayed in a captured image display field 213 every time the imaging object moves. The captured image display field 213 displays a captured image analyzed by the display screen control unit 125 based on captured image data involved in the LAN transmission data received from the exposure apparatus 100 via the LAN 120.

The display unit 123 continuously receives still images captured by the A-scope 105 and the B-scope 106 (involved in the LAN transmission data) and displays each received image in the captured image display field 213. Therefore, an operator viewing the captured image display field 213 can observe the image images as a real-time moving image of the mask stage 102 or the wafer stage 104.

The captured image display field 213 can display any other image, such as an auxiliary scale 214 that indicates a central coordinate of a captured image, superimposed on a captured image involved in the LAN transmission data.

The search operation screen 200 includes a moving operation unit that enables an operator to change the position of an imaging object displayed in the captured image display field 213. The moving operation unit is, for example, a direction button functioning as an image interface or a manual input unit that enables an operator to directly input position coordinates of a destination. For example, if an operator presses (clicks) a direction button of a stage driving direction operation field 217, the position of an imaging object of the mask stage 102 or the wafer stage 104 moves in the designated direction by a distance being set in a stage direction drive distance input field 216.

If the moving operation unit allows an operator to directly input position coordinates of a destination, the captured image display field 213 displays an image captured at an XY-coordinate position being set in a drive position input field 219. The moving operation unit includes a drive position input mode switching button 218. The drive position input mode switching button 218 enables an operator to select an absolute coordinate input mode or a relative coordinate input mode.

If an operator presses a stage drive operation button 220 in the absolute coordinate input mode, the captured image display field 213 displays images of the mask stage 102 and the wafer stage 104 captured at positions set in the drive position input field 219. Furthermore, if an operator presses the stage drive operation button 220 in the relative coordinate input mode, the captured image display field 213 displays images of the mask stage 102 and the wafer stage 104 captured at positions obtained by adding set values in the drive position input field 219 to the present imaging positions.

Furthermore, if an operator operates the stage driving direction operation field 217 or presses the stage drive operation button 220, the display screen control unit 125 generates a stage drive request command. The stage drive request command includes a stage driving amount being set by an operator through the stage driving direction operation field 217 or the stage drive operation button 220. The LAN transmission/reception unit 124 transmits the stage drive request command to the exposure apparatus 100 via the LAN 120. In the exposure apparatus 100, the LAN transmission/reception unit 117 receives the stage drive request command transmitted from the external computer terminal 121. The console control unit 115 receives the stage drive request command from the LAN transmission/reception unit 117.

The console control unit 115 determines a target stage (i.e., a drive object) based on drive object stage information included in the stage drive request command. The console control unit 115 generates an actual stage drive command corresponding to the stage driving amount contained in the stage drive request command. The console control unit 115 transmits the actual stage drive command to the mask stage control unit 111 or the wafer stage control unit 113 according to the determined target stage. The mask stage control unit 111 or the wafer stage control unit 113 receives the actual stage drive command and drives the mask stage 102 or the wafer stage 104.

Accordingly, the imaging position of the mask stage 102 captured by the A-scope 105 and the imaging position of the wafer stage 104 captured by the B-scope 106 relatively move. The A-scope 105 and the B-scope 106 generate video signals having different imaging contents.

Therefore, the console control unit 115 generates LAN transmission data including video signals from the A-scope 105 and the B-scope 106 reflecting the mask stage 102 and the wafer stage 104 having been moved. The LAN transmission/reception unit 117 transmits the LAN transmission data to the external computer terminal 121 via the LAN 120. Thus, the external computer terminal 121 receives the LAN transmission data including images of the mask stage 102 and the wafer stage 104 having been moved in response to an operator's input via the stage driving direction operation field 217 or the stage drive operation button 220.

The operation of the external computer terminal 121 includes continuously performing the above-described moving instruction and displaying an image of the mask stage 102 or the wafer stage 104 having been moved again. Therefore, an operator of the external computer terminal 121 can observe an image displayed in the captured image display field 213 as a real-time image of the mask stage 102 or the wafer stage 104 of the exposure apparatus 100.

Furthermore, even when an alignment mark is not recognized when a search operation is started, the alignment mark appears as an alignment mark 215 in the captured image display field 213 as a result of the performed search operation. The above-described operation can be performed similarly in both the above-described absolute coordinate input mode and the relative coordinate input mode.

The state display field 201, the stage driving direction operation field 217, the drive position input field 219, and the stage drive operation button 220 of the search operation screen 200 constitute an alignment mark search operation unit. In the first exemplary embodiment, the display screen control unit 125 of the external computer terminal 121 and the search operation screen 200 (mainly, the captured image display field 213)) constitute a composite image generation unit.

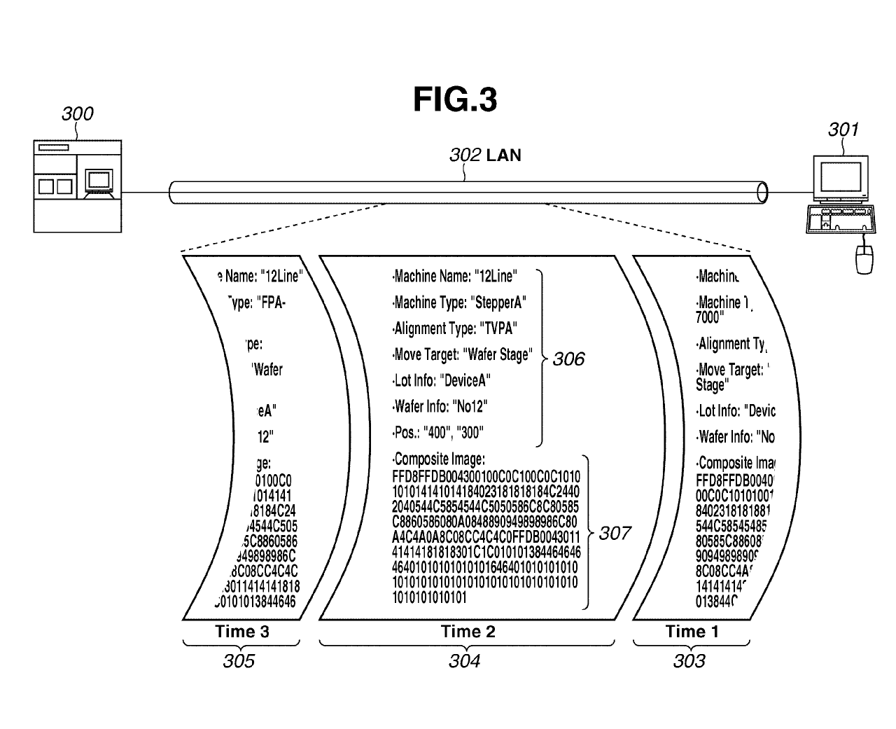

FIG. 3 illustrates an exemplary data structure of the LAN transmission data transmitted between an external computer terminal 301 and an exposure apparatus 300 during an alignment mark search operation. The LAN transmission data includes information 303, 304, and 305 sectioned in Time 1, Time 2, and Time 3. LAN transmission data 304 in Time 2 includes imaging object information 306, such as apparatus information and imaging position.

Furthermore, the LAN transmission data includes a still image 307 generated by the console control unit 115 converting a video signal captured by the A-scope 105 or the B-scope 106. The external computer terminal 301 (121) continuously displays a still image on its operation screen based on still image information contained in the LAN transmission data, which is updated at predetermined time intervals. Thus, an operator of the external computer terminal 301 (121) can observe the image as a moving image.

The console control unit 115 continuously generates LAN transmission data and outputs the generated data to the LAN transmission/reception unit 117. However, if the stage drive request is not received from the external computer terminal 301 (121), the A-scope 105 and the B-scope 106 capture unchanged stage positions. In this case, the console control unit 115 stops transmitting LAN transmission data to the LAN transmission/reception unit 117. Thus, the captured image display field 213 of the search operation screen 200 displays an image based on the latest LAN transmission data transmitted last from the exposure apparatus 300 (121). In this manner, if the imaging objects captured by the A-scope 105 and the B-scope 106 do not change their positions, the console control unit 115 interrupts transmitting image data via the LAN 302 (120) and, therefore, can reduce a total amount of data transmitted via the LAN 302.

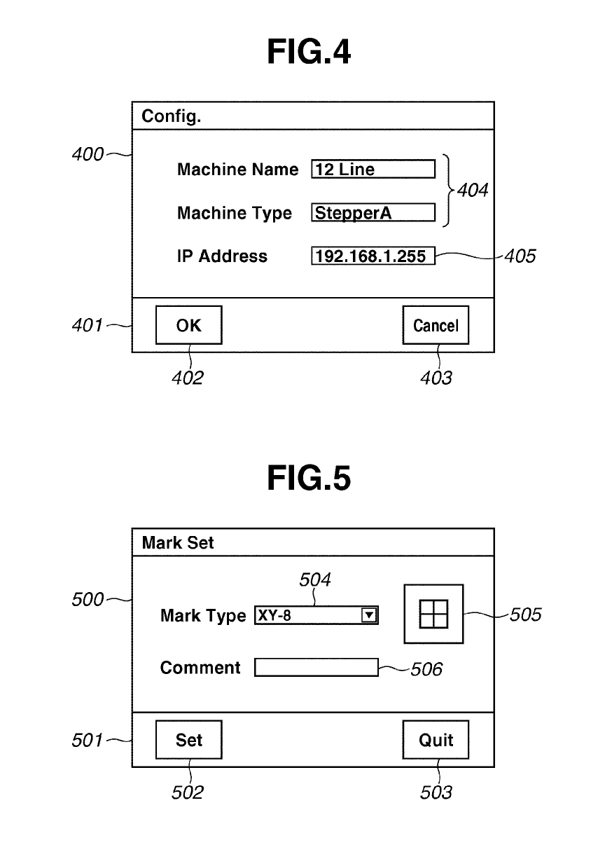

FIG. 4 illustrates an exemplary setting screen 400, which can be displayed when an operator presses a setting screen start button 210 positioned in a button display field 206 of the search operation screen 200. The setting screen 400 includes an apparatus information input field 404, which enables an operator to set identification information (e.g., apparatus name, type name, etc.) of an operation object (e.g., the exposure apparatus 100).

The setting screen 400 further includes an apparatus network address input field 405, which enables an operator to input network address information identifying an operation object (e.g., the exposure apparatus 100) selected from a plurality of exposure apparatuses connected to the LAN 120. The setting screen 400 further includes a button display field 401, which displays a setting finalization button 402 and a setting cancellation button 403.

An operator can instruct, by pressing the setting finalization button 402, initiating an operation for designating the apparatus in the apparatus network address input field 405 as a search object. More specifically, the LAN transmission/reception unit 117 of the search object (the apparatus designated in the apparatus network address input field 405) communicates with the LAN transmission/reception unit 124 of the external computer terminal 121.

When there are a plurality of exposure apparatuses 100, 118, and 119 connected to the LAN 120 as illustrated in FIG. 1, the apparatus network address input field 405 enables an operator to easily switch the operation object of the search screen by changing the contents in the field 405. As described above, the external computer terminal 121 can display an image as a real-time image captured by an alignment camera of the exposure apparatus 100.

According to the above-described arrangement that enables an operator of the external computer terminal 121 to control the mask stage 102 and the wafer stage 104, an on-line system operator can remotely control the exposure apparatus 100 placed in a clean room. A remote-control operator is not required to approach the exposure apparatus 100 or wear a clean suit for a clean room. Thus, the work efficiency in an alignment mark search operation can be improved greatly. Furthermore, the external computer terminal 121 is configured to enable an operator to switch an alignment assist operation object (e.g., the exposure apparatus 100). Therefore, each exposure apparatus does not require a dedicated alignment assist operation terminal. The total cost can be reduced greatly.

### Second Exemplary Embodiment

Next, a second exemplary embodiment of the present invention is described based on the above-described arrangement of the first exemplary embodiment. The search operation screen 200 according to the second exemplary embodiment can be displayed by the external computer terminal 121 as described in the first exemplary embodiment or can be displayed by the display unit 108 of the exposure apparatus 100.

The following processing can be executed by the console control unit 115, which controls the display unit 108 of the exposure apparatus 100, or can be executed by the display screen control unit 125, which controls the display unit 123 of the external computer terminal 121.

As illustrated in FIG. 2, the search operation screen 200 includes a composite image display field 221, which displays a composite image 224 as a combination of images displayed in the captured image display field 213 corresponding to a plurality of imaging positions after a search is started. The display screen control unit 125 of the external computer terminal 121 and the search operation screen 200 (mainly, the composite image display field 221) constitute a composite image generation unit.

The composite image display field 221 further displays an imaging area frame 225 that indicates a rectangular area currently displayed in the captured image display field 213. The imaging area frame 225 enables an operator to easily check a positional relationship between the composite image 224 and an imaging position of the captured image display field 213. Thus, the display of the imaging area frame 225 is effective to reduce unnecessary search operations for already searched regions. The composite image display field 221 includes a display scaling scroll bar 223 that enables an operator to magnify or reduce an image in the composite image display field 221.

When a magnified image is displayed in the composite image display field 221 according to an operation using the display scaling scroll bar 223, the composite image display field 221 may display only a part of the composite image 224. In this case, an operator can perform the following operations.

If the external computer terminal 121 displays the composite image 224, an operator can press a cursor key of the input unit 122 to move the position of the composite image 224 displayed in the composite image display field 221. If the exposure apparatus 100 displays the composite image 224, an operator can press a cursor key of the input unit 107 to move the position of the composite image 224 displayed in the composite image display field 221.

When an alignment mark is discovered as a result of search, a mark icon 226 can be put on the composite image 224 as information memorizing the position of the alignment mark. An operator can add the mark icon 226 to the composite image 224 on a mark icon setting screen 500 (see FIG. 5), which is described below later. A mark list 227 displays a list of mark icons 226 added to the composite image 224. The mark list 227 displays identification information of the mark icon 226, which includes the shape/type of each alignment mark, position coordinates of the mask stage 102 or the wafer stage 104 to which the mark icon 226 is attached, and comments.

The display screen control unit 125 and the mark icon 226 constitute an addition unit configured to add, to the composite image 224, an alignment mark shape and coordinate information of the mask stage 102 or the wafer stage 104. Furthermore, the addition unit includes the mark list 227 and the mark icon setting screen 500.

The button display field 206 of the search operation screen 200 displays a search history save button 207, a mark setting screen start button 208, a mark position applying button 209, the setting screen start button 210, a search history screen start button 211, and an operation screen closure button 212.

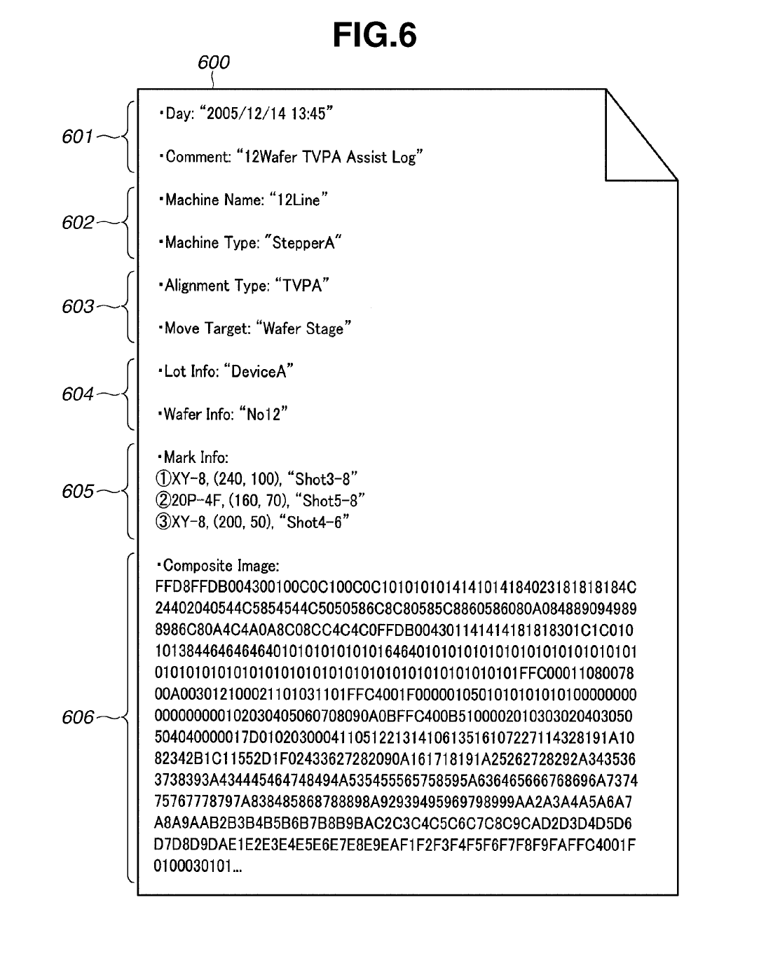

If an operator presses the search history save button 207, a search history file 600 (refer to FIG. 6) is generated based on search information obtained using the search operation screen 200. The storage device 116 or 126 stores each generated search history file 600. The search history file 600 includes file identification information 601 (e.g., file generation time and comment) and apparatus information 602 (e.g., apparatus name and apparatus type number of a search object).

The search history file 600 further includes alignment information 603 (e.g., alignment type and drive object stage) and material information 604 (e.g., lot number and wafer number of a search object).

The search history file 600 further includes mark information 605 (e.g., information of the mark list 227 added below the composite image display field 221 on the search operation screen 200) and composite image information 606 (i.e., image data in the composite image display field 221 of the search operation screen 200.

If an operator presses the mark setting screen start button 208, the composite image display field 221 displays the mark icon setting screen 500 illustrated in FIG. 5. If an operator presses the mark position applying button 209, the drive position input field 219 displays positional information of the mark selected from the mark list 227. If an operator presses the mark position applying button 209 in a state where a selection state mark 228 is present in the mark list 227, the drive position input field 219 displays coordinate information of the selection state mark 228.

If an operator presses the mark position applying button 209 and the stage drive operation button 220 successively, the captured image display field 213 displays an image including a mark position. If an operator presses the search history screen start button 211, the display unit 108 or 123 displays a search history screen 700 including a list of search history files 600 read from the storage device 116 or 126. The mark setting screen start button 208, the mark position applying button 209, the drive position input field 219, and the stage drive operation button 220 constitute part of the addition unit. An operator can close the search operation screen 200 by pressing the search screen closure button 212.

The following screens are displayed when an operator presses buttons included in the button display field 206. FIG. 5 illustrates an example of the mark icon setting screen 500 displayed when an operator presses the mark setting screen start button 208. The following processing can be executed by the console control unit 115, which controls the display unit 108 of the exposure apparatus 100, or by the display screen control unit 125, which controls the display unit 123 of the external computer terminal 121.

As illustrated in FIG. 5, the mark icon setting screen 500 includes an alignment mark input field 504, which enables an operator to designate the shape/type of an alignment mark (a mark icon) added to the composite image 224. The alignment mark input field 504 can display a plurality of alignment marks and enables an operator to select a desired alignment mark.

The mark icon setting screen 500 further includes a mark icon display field 505, which displays an image corresponding to the alignment mark selected in the alignment mark input field 504. The mark icon setting screen 500 further includes a comment input field 506, which enables an operator to input comment information identifying a mark. The mark icon setting screen 500 further includes a button display field 501, which displays a mark addition button 502 and a mark setting screen closure button 503. The mark addition button 502 is an interface that adds alignment mark information input in the mark icon setting screen 500 to the composite image 224.

If an operator presses the mark addition button 502, a mark icon appears on the composite image 224. The mark icon indicates a position corresponding to the central position of the captured image display field 213 of the search operation screen 200. Furthermore, the information (e.g., shape/type) of an alignment mark set on the mark icon setting screen 500 and coordinate information of the mask stage 102 or the wafer stage 104 indicated by the mark icon are added to the mark list 227.

By pressing the mark setting screen closure button 503, an operator can discard any change added on the mark icon setting screen 500 and close the mark icon setting screen 500. The mark icon display field 505 and the mark addition button 502 are constituent components of the addition unit.

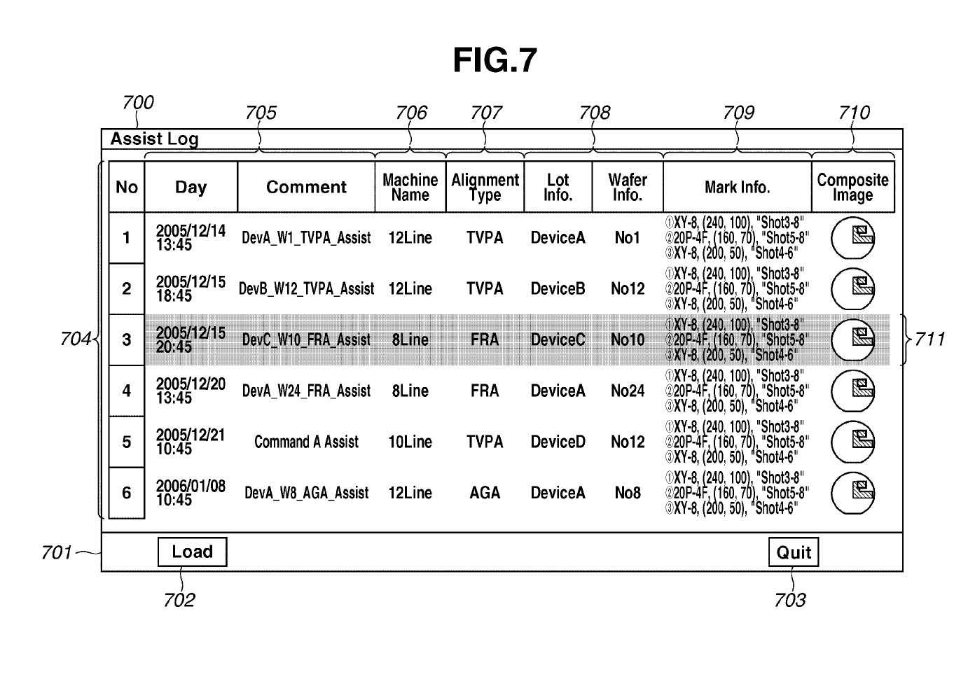

FIG. 7 illustrates an exemplary search history screen 700 displayed when an operator presses the search history screen start button 211. The following processing can be executed by the console control unit 115, which controls the display unit 108 of the exposure apparatus 100, or by the display screen control unit 125, which controls the display unit 123 of the external computer terminal 121.

As illustrated in FIG. 7, a search history list display field 704 displays a list of search history files 600 stored in the storage device 116 or 126. Each row of the search history list display field 704 displays the contents of one search history file 600. A history identification information display field 705 displays the file identification information 601 of the search history file 600. An apparatus information display field 706 displays the apparatus information 602 of the search history file 600. An alignment display field 707 displays the alignment information 603 of the search history file 600.

A material information display unit 708 displays the material information 604 of the search history file 600. A mark information display unit 709 displays the mark information 605 of the search history file 600. A composite image display field 710 displays a reduced image of the composite image information 606 of the search history file 600.

When the search history list display field 704 displays a list of past search history files 600, an operator can easily check whether a present search object (i.e., a mask or a wafer) of the search operation screen 200 has ever been searched by any other exposure apparatus.

The search history screen 700 includes a button display field 701, which displays a history read button 702 and a history screen closure button 703. The history read button 702 is an interface that enables an operator to load the history item 711 selected in the search history list display field 704 into the search operation screen 200. The history screen closure button 703 is an interface that enables an operator to close the search history screen 700.

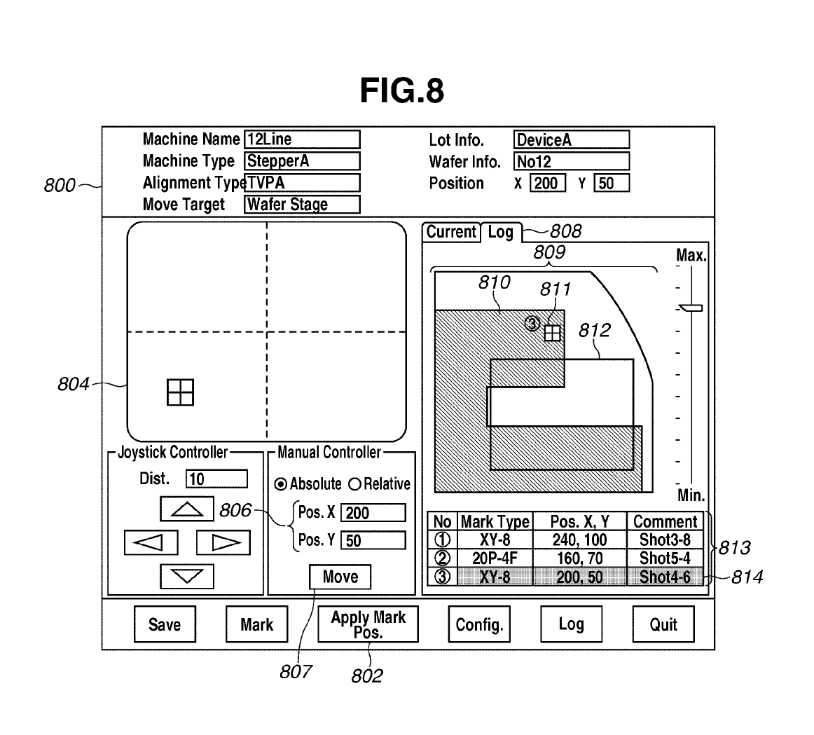

FIG. 8 illustrates an exemplary search operation screen 800, which is displayed when an operator presses the history read button 702 on the search history screen 700. The following processing can be executed by the console control unit 115, which controls the display unit 108 of the exposure apparatus 100, or by the display screen control unit 125, which controls the display unit 123 of the external computer terminal 121.

If an operator switches to a search history display tab using a composite image display switching tab 808 in a state where the search operation screen 800 displays a readout search history as illustrated in FIG. 8, a composite image display field 809 displays the following information. The composite image display field 809 displays a composite image 810, which is included in the selection state history 711 selected on the search history screen 700, together with a mark icon 811 and a mark list 813.

Furthermore, the composite image display field 809 displays an imaging area frame 812 that represents an imaging area of a captured image display field 804 that displays a real-time image. The search operation screen 800 simultaneously displays a real-time image captured by the A-scope 105 or the B-scope 106 displayed in the captured image display field 804 and a composite image 810 of past searched images displayed in the composite image display field 809.

Therefore, an operator can effectively perform a search operation by referring to the past search history without repetitively searching the same position. Furthermore, if the captured image display field 804 displays the position of a mark icon included in the search history, the following procedure becomes feasible.

More specifically, an operator selects a history tab with the composite image display switching tab 808 and selects an intended mark (e.g., a selection state mark 814) from the mark list 813, then presses a mark position applying button 802.

Then, a drive position input field 806 displays mark coordinates included in the selection state mark 814. Furthermore, if an operator presses a stage drive operation button 807 in a state where the positional information of the selection state mark 814 is set in the drive position input field 806, the captured image display field 804 displays the following information.

More specifically, the captured image display field 804 displays images obtained by the A-scope 105 and the B-scope 106 capturing the positions of the mask stage 102 and the wafer stage 104 indicated by mark icons having been set previously. As described above, the display unit 108 of the exposure apparatus 100 or the display unit 123 of the external computer terminal 121 can simultaneously display an image captured by the A-scope 105 or the B-scope 106 and a composite image of images indicating the mask stage position or wafer stage position.

Thus, an operator can check a positional relationship between the search path and a displayed captured image and can reduce operation errors without repeatedly searching the same place. The work efficiency can be improved greatly.

Furthermore, an operator can record a history of a composite image and mark information added to the image, and also can easily perform a re-search operation for a mask or a wafer that has ever been subjected to an alignment mark search operation performed by the same exposure apparatus or another exposure apparatus.

Namely, an operator can shorten a manual alignment mark search operation (does not need to start the operation from the beginning) because the history information is available. Therefore, the work efficiency can be improved greatly.

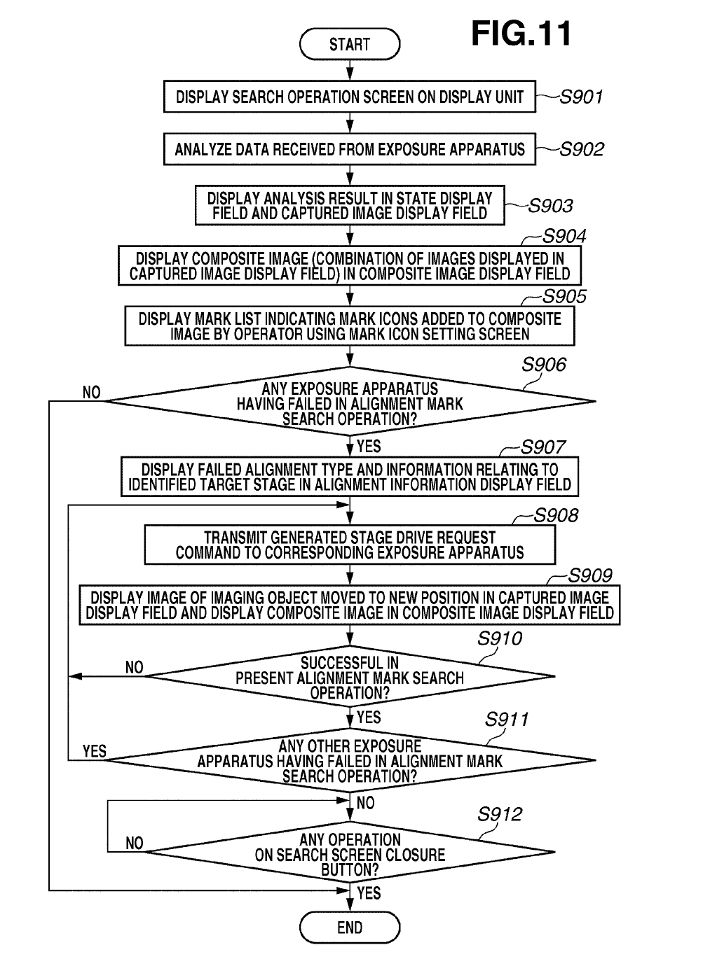

FIG. 11 is a flowchart illustrating a procedure of processing performed by the computer terminal 121 based on a program according to an exemplary embodiment of the present invention. Note that the program can also be executed by the console control unit 115 of the exposure apparatus 100.

In step S901, the external computer terminal 121 displays the search operation screen 200 illustrated in FIG. 2 on the display unit 123.

In step S902, the external computer terminal 121 analyzes the LAN transmission data received from the exposure apparatus 100, 118, or 119 via the LAN 120.

In step S903, the state display field 201 of the search operation screen 200 displays an analysis result of the LAN transmission data. The captured image display field 213 displays an image. For example, the state display field 201 including corresponding display fields successively displays apparatus information, alignment information, material information, and imaging positional information of the exposure apparatus 100, 118, or 119 based on the analysis result. Furthermore, the captured image display field 213 successively displays images captured by the A-scope 105 or the B-scope 106 in the exposure apparatus 100, 118, or 119.

In step S904, the composite image display field 221 of the search operation screen 200 displays the composite image 224 as a combination of images displayed in the captured image display field 213 corresponding to a plurality of imaging positions after a search is started. Namely, the external computer terminal 121 generates a composite image including image information obtained from the exposure apparatus 100 with reference to the imaging position of at least one of the mask stage 102 and the wafer stage 104 and displays the generated composite image in the composite image display field 221.

The composite image display field 221 displays the imaging area frame 225, which indicates a rectangular area currently displayed in the captured image display field 213. Thus, an operator can easily check a positional relationship between the composite image 224 and a captured image in the captured image display field 213. Furthermore, an operator can magnify or reduce the image in the composite image display field 221 by operating the display scaling scroll bar 223.

If the scaling adjustment with the display scaling scroll bar 223 causes any undesirable result, an operator can operate the cursor key of the input unit 122 to move the position of the composite image 224 in the composite image display field 221. The mark icon 226 added to the composite image 224 is information memorizing the position of the alignment mark discovered as a result of search.

In step S905, an operator can add the mark icon 226 to the composite image 224 using the mark icon setting screen 500. The mark list 227 for the composite image 224 displays a list of mark icons 226 added to the composite image 224. The external computer terminal 121 adds further information to the composite image 224. The information added to the composite image 224 includes shape information of an alignment mark attached to at least one of a mask and a wafer and coordinate information including coordinates of at least one of the mask stage 102 and the wafer stage 104.

In step S906, based on the analysis result, the external computer terminal 121 determines whether there is any exposure apparatus that has failed in the alignment mark search operation. If there is no exposure apparatus that has failed in the alignment mark search operation (NO in step S906), the external computer terminal 121 terminates the processing of this routine. On the other hand, if there is any exposure apparatus that has failed in the alignment mark search operation (YES in step S906), the processing flow proceeds to step S907.

In step S907, the state display field 201 displays the above-described information of the exposure apparatus that has failed in the alignment mark search operation or maintains the state of display if the above-described information is already displayed. The alignment information display field 203 displays an alignment type that requires a re-search operation due to failure in the mark search operation or information relating to a target stage (a drive object) identified by the search. Furthermore, the captured image display field 213 displays an image captured by the A-scope 105 or the B-scope 106 of the exposure apparatus that has failed in the mark search operation.

In step S908, the external computer terminal 121 checks the presence of any instruction input via the button display field 206, the stage driving direction operation field 217, and the drive position input mode switching button 218 on the search operation screen 200.

For example, if in step S908 the external computer terminal 121 recognizes a user's operation on any direction button in the stage driving direction operation field 217 in a condition where a moving distance is set in the stage direction drive distance input field 216, the external computer terminal 121 performs the following processing.

Namely, the external computer terminal 121 generates a stage drive request command for moving an imaging object (the mask stage 102 or the wafer stage 104) in the direction designated by the direction button and to the position designated by the moving distance having being set. Then, the external computer terminal 121 transmits the generated stage drive request command to the corresponding exposure apparatus.

If in step S908 the external computer terminal 121 recognizes any input of drive position in the drive position input field 219 and any operation on the stage drive operation button 220 in a condition where the drive position input mode switching button 218 selects the absolute coordinate input mode, the external computer terminal 121 performs the following processing.

Namely, the external computer terminal 121 generates a stage drive request command for moving an imaging object (the mask stage 102 or the wafer stage 104) to the position designated by the input drive position (XY-drive position). Then, the external computer terminal 121 transmits the generated stage drive request command to the corresponding exposure apparatus.

When the exposure apparatus receives a stage drive request command from the external computer terminal 121, the exposure apparatus performs processing similar to that described in the first exemplary embodiment.

In step S909, the captured image display field 213 displays an image of the imaging object moved to a new position, based on LAN transmission data transmitted from the exposure apparatus that has failed in the last mark search operation. Furthermore, step S909 includes the above-described processing performed in step S904 (i.e., displaying a composite image in the composite image display field 221).

In step S910, the external computer terminal 121 analyzes the LAN transmission data transmitted from the exposure apparatus that has failed in the last mark search operation and determines whether the present alignment mark search operation is successful.

If the alignment mark search operation performed by the exposure apparatus that has failed in the previous mark search operation is successful (YES in step S910), the external computer terminal 121 determines the presence of any operation on the search history save button 207 of the button display field 206.

If any operation on the search history save button 207 is recognized, the external computer terminal 121 generates the search history file 600 based on the search information input on the search operation screen 200. The storage device 126 stores the generated search history file 600. If an operator presses the search history screen start button 211, an image of each search history file 600 can be displayed. In this case, a captured image in the captured image display field 213, which may include an alignment mark, and a composite image included in the search history information can be simultaneously displayed.

However, if the present alignment mark search operation is failed (NO in step S910), the external computer terminal 121 repeats the processing of steps S908 to S910.

Then, in step S911, the external computer terminal 121 determines whether there is any other exposure apparatus that has failed in the mark search operation. If there is any other exposure apparatus that has failed in the mark search operation (YES in step S911), the processing flow returns to step S908. If there is no other exposure apparatus that has failed in the mark search operation (NO in step S911), the processing flow proceeds to step S912. In step S912, the external computer terminal 121 determines the presence of any operation on the search screen closure button 212 in the button display field 206.

If an operator presses any button other than the search screen closure button 212, the external computer terminal 121 performs the processing corresponding to the button operation as described in the second exemplary embodiment. However, if in step S912 any operation on the search screen closure button 212 is recognized (YES in step S912), the external computer terminal 121 terminates the processing of this routine.

As described above, the program according to an exemplary embodiment enables an operator of the external computer terminal 121 to perform an alignment mark search operation while monitoring images of a mask and a wafer in the exposure apparatus 100 accessible via the LAN 120 from the external computer terminal 121.

Accordingly, an operator of an on-line host computer can manage each of a plurality of exposure apparatuses from a remote place and is not required to approach the exposure apparatus even if an alignment mark search operation is failed. Thus, the work efficiency can be improved greatly.

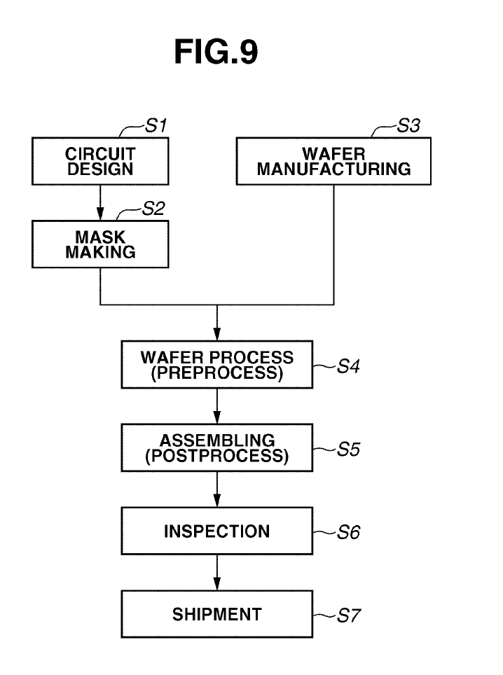

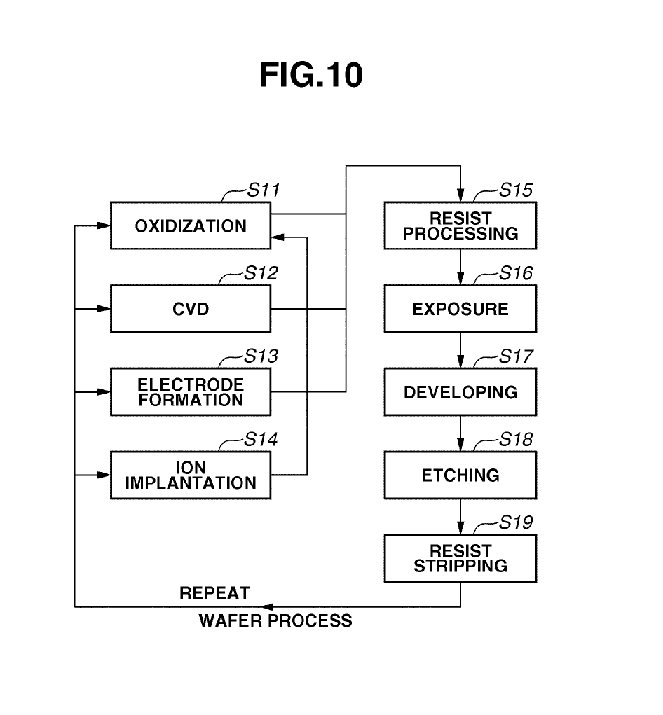

Next, an exemplary device manufacturing method using the above-described exposure apparatus is described with reference to FIGS. 9 and 10. FIG. 9 is a flowchart illustrating exemplary manufacturing processes for a semiconductor device (e.g., an integrated circuit (IC), a large scale integration (LSI), a liquid crystal display (LCD), and a charge-coupled device (CCD)). Step S1 is a circuit design process for designing a circuit of a semiconductor device. Step S2 is a mask making process for fabricating a mask, which can be referred to as an original plate or a reticle, based on a designed circuit pattern.

Step S3 is a wafer manufacturing process for manufacturing a wafer, which can be referred to as a substrate, from a silicon or comparable material. Step S3 can be a reticle manufacturing process. Step S4 is a wafer process, which can be referred to as “preprocess”, for forming an actual circuit on a wafer using an exposure apparatus with the above-described prepared mask according to the lithography technique.

Step S5 is an assembling process, which can be referred to as “postprocess”, for forming a semiconductor chip using the wafer manufactured in step S4. The postprocess includes an assembly process (e.g., dicing, bonding, etc.) and a packaging process (chip sealing). Step S6 is an inspection process for inspecting the semiconductor device manufactured in step S5. The inspection includes an operation confirmation test and an endurance test. Step S7 is a shipment process for shipping the semiconductor device completed through the above-described processes.

As illustrated in FIG. 10, the above-described wafer process in step S4 includes an oxidation step S11 for oxidizing a wafer surface, a chemical vapor deposition (CVD) step S12 for forming an insulating film on the wafer surface, and an electrode formation step S13 for forming electrodes on the wafer by vaporization. Furthermore, the wafer process in step S4 includes an ion implantation step S14 for implanting ions into the wafer, a resist processing step S15 for coating the wafer with a photosensitive material, and an exposure step S16 for exposing the wafer subjected to the resist processing step to light using the above-described exposure apparatus with a mask having a circuit pattern.

Furthermore, the wafer process in step S4 includes a developing step S17 for developing the wafer exposed in the exposure step S16, an etching step S18 for cutting a portion other than a resist image developed in the developing step S17, and a resist stripping step S19 for removing an unnecessary resist remaining after the etching step S18. The processing repeating the above-described steps can form multiple circuit patterns on a wafer.

An exemplary device manufacturing method using the above-described exposure apparatus can improve the work efficiency in manufacturing a device and can increase the productivity of a device. As described above, the above-described exemplary embodiments can improve the work efficiency in a mark search operation.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-326378 filed Dec. 1, 2006, which is hereby incorporated by reference herein in its entirety.

What is claimed is:

1. An exposure apparatus configured to measure a position of at least one of a mark formed on an original plate and a mark formed on a substrate and to expose the substrate to radiant energy based on the measured position, the apparatus comprising:
a stage configured to hold one of the original plate and the substrate and to be moved;
a scope configured to capture an image of the mark formed on one of the original plate and the substrate held by the stage;
an input unit configured to be operated to instruct a position of the stage;
a display; and
a controller configured to combine images respectively captured by the scope at a plurality of positions of the stage instructed by the input unit into a combined image and to cause the display to display the combined image.

2. An apparatus according to claim 1, wherein the controller is configured to cause the display to display the combined image and the captured image.

3. An apparatus according to claim 1, wherein the input unit is configured to be operated to designate a position of the mark in the combined image.

4. An apparatus according to claim 3, further comprising a storage configured to store information of the combined image and information of the designated position of the mark.

5. An apparatus according to claim 4, wherein the controller is configured to cause the display to display information identifying the stored information.

6. An apparatus according to claim 5, wherein the input unit is configured to be operated to designate the identified information, and
wherein the controller is configured to cause the display to display information of the combined image corresponding to the designated information and information of the designated position of the mark corresponding to the designated information.

7. An operation apparatus configured to operate an exposure apparatus, wherein the exposure apparatus includes a stage configured to hold one of an original plate and a substrate and to be moved and a scope configured to capture an image of a mark formed on one of the original plate and the substrate held by the stage, measures a position of the mark, and exposes the substrate to radiant energy based on the measured position, the operation apparatus comprising:
an input unit configured to be operated to instruct a position of the stage;
a display; and
a controller configured to combine images respectively captured by the scope at a plurality of positions of the stage instructed by the input unit into a combined image and to cause the display to display the combined image.

8. A computer-readable medium including computer-executable instructions for operating an exposure apparatus, wherein the exposure apparatus includes a stage configured to hold one of an original plate and a substrate and to be moved and a scope configured to capture an image of a mark formed on one of the original plate and the substrate held by the stage, measures a position of the mark and exposes the substrate to radiant energy based on the measured position, the medium comprising:
computer-executable instructions for receiving information instructing a position of the stage from an input unit;
computer-executable instructions for combining images respectively captured by the scope at a plurality of instructed positions of the stage into a combined image; and
computer-executable instructions for causing a display to display the combined image.

9. A method of manufacturing a device using an exposure apparatus configured to measure a position of at least one of a mark formed on an original plate and a mark formed on a substrate and to expose the substrate to radiant energy based on the measured position,
the exposure apparatus including,
a stage configured to hold at least one of the original plate and the substrate and to be moved;
a scope configured to capture an image of the mark formed on one of the original plate and the substrate held by the stage;
an input unit configured to be operated to instruct a position of the stage;
a display; and
a controller configured to combine images respectively captured by the scope at a plurality of positions of the stage instructed by the input unit into a combined image and to cause the display to display the combined image;
the method comprising:
exposing a substrate to radiant energy using the exposure apparatus;
developing the exposed substrate; and
processing the developed substrate to manufacture the device.
